(19) United States
(12) Patent Application Publication
(10) Pub. No.: US 2008/0104126 A1
(43) Pub. Date: May 1, 2008

(54) METHOD AND SYSTEMS FOR SHARING DATA WITH MOBILE MULTIMEDIA PROCESSORS

(75) Inventors: RICARDO MARTINEZ-PEREZ, PLANTATION, FL (US); DOMINIK BUSZKO, WESTON, FL (US); ADEEL MUKHTAR, CORAL SPRINGS, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/554,334

(22) Filed: Oct. 30, 2006

(51) Int. Cl. G06F 17/30

(52) U.S. Cl. 707/200

(57) ABSTRACT

A multimedia processor system (400) for a mobile device, the system includes a central processing unit (CPU) (105), a system bus port (120) accessible by the CPU, and a virtual file system (VFS) (110) accessible by the CPU. The VFS is synchronized with a remote file system (210) of a remote application processor (200) coupled to the system bus port. The system further includes at least one storage device port (130) accessible by the CPU and at least one storage device pass-thru port (140) coupled to the at least one storage device port by a pass-thru controller (150) managed by the CPU, where the CPU instructs the pass-thru controller to disable access of the at least one pass-thru port to the at least one storage device port.

### FIELD

This invention relates generally to mobile devices, and more particularly to a reduced power system and methods for sharing data between multiple processors in a mobile device.

### BACKGROUND

As mobile devices become more advanced by providing multimedia features, such as audio and video playback, the tendency of such systems is to require additional power to efficiently operate the mobile device. However, even though users desire that the capabilities of advanced mobile devices increase, at the same time they require that such devices be more energy efficient and provide longer battery life. Additionally, it is not desired that the size of the mobile device increase to allow a larger battery, instead, users desire smaller devices with longer battery lifetime.

Advanced mobile devices require additional power since the tasks required for the mobile device to operate are generally divided among several different types of processors, including a multimedia accelerator and a baseband processor or application processor. Power consumption is also further increased when the mobile device incorporates a storage device which the multiple processors need to access efficiently. The main problem in such systems is that the several processors generally cannot share file systems and storage devices efficiently. However, there are several known methods of providing file sharing capabilities among multiple processors, but each having limitations.

A first known method utilizes a file system running on an application processor, but with the storage device being directly coupled to a multimedia processor, as shown in FIG. 1. In this configuration, the multimedia processor is not capable of accessing the storage device without instructions from the application processor. Some data can be buffered on the multimedia processor memory to avoid having to transfer data all the way to the application processor only to transfer the data back to the multimedia processor, but such an operation still requires intensive application processor intervention. In such an arrangement, the application processor would be required to run at all times in order to handle the data pipe when the multimedia processor is playing or recording an audio or video file.

A second known method utilizes a file system running on an application processor and with a storage device being also directly coupled to an application processor, as shown in FIG. 2. In this configuration, the advantage is that if the multimedia processor is not being used, the multimedia processor can be placed into a low power mode when the application processor is accessing the storage device. The disadvantage, though, is that when playing or recording media files, both the multimedia processor and the applications processor need to operate at full power. For example, if playing video and all the parsing of the file, video decoding, and audio decoding is done on the multimedia processor, the applications processor will have to operate at all times in order to handle the data transfer and handling. While this is an improvement over other configurations, there is still a significant power consumption penalty during multimedia operations.

A third known method utilizes a file system running on a multimedia processor and a storage device is also connected to the multimedia processor as shown in FIG. 3. In this configuration, whenever an application processor needs to access the file system, the application processor will issue commands to the multimedia processor. In terms of multimedia applications, the advantage of this configuration is that the multimedia processor can play and record media files on its own directly to or from the storage device. Additionally, during such media file operations, the applications processor can operate in a low power mode. The disadvantage, though, is that this configuration requires that any time the applications processor needs to access any type of data, the multimedia processor will have to run at full power to support all file system requests of the application processor.

As described above, systems and methods to provide efficient file sharing between multimedia processors and application processors do not exist. Current designs available to provide this functionality suffer from two main drawbacks: (1) power consumption is higher, since the two systems must operate at the same time during file sharing, and (2) data must be often transferred from a first processor to second processor, only to have to transfer the data back to the first processor, thereby increasing not only power consumption, but port bandwidth requirements. Therefore, a method or system for sharing multimedia data processing on a mobile device that allows data on a storage device coupled to a processor or a file system of a processor to be shared among multiple processors, including a multimedia processor, while minimizing power consumption is lacking in the marketplace.

### SUMMARY OF THE INVENTION

Embodiments in accordance with the present invention can provide a pass-thru multimedia processor system and methods that provide for file sharing between the multimedia processor and an application or baseband processor configured to optimize battery life of a mobile device.

In a first embodiment, a multimedia processor system for a mobile device can include a central processing unit (CPU), a system bus port accessible by the CPU, a virtual file system (VFS) accessible by the CPU where the VFS is synchronized with a remote file system of a remote application processor coupled to the system bus port, at least one storage device port accessible by the CPU, and at least one storage device pass-thru port coupled to the at least one storage device port by a pass-thru controller managed by the CPU, where the CPU instructs the pass-thru controller to disable access of the at least one pass-thru port to the at least one storage device port. The multimedia processor can be further configured to be active only during multimedia events and dormant during other events on the mobile device. The multimedia processor can also be configured to automatically enable the pass-thru ports when the CPU is dormant. The multimedia processor can also be further configured to be able to process an incoming multimedia stream and record the stream directly to a mass storage device without intervention from the applications processor.

In a second embodiment of the invention, a method for processing data with a multimedia processor with a pass-thru architecture can include the steps of disabling at least one pass-thru port by instructing a data pass-thru controller to decouple at least one storage device port from at least one external pass-thru port, accessing at least one data source connected to at least one storage device port, retrieving data from at least one data source (where at least a portion of the retrieved data comprises multimedia data), storing the data in a virtual file system of the multimedia processor (where the virtual file system of the multimedia processor is synchronized with a remote file system of a remote applications processor), and processing the data stored in the virtual file system. The method can further include the steps of processing data while the applications processor is dormant. The method can also include recording multimedia data from a data source onto a mass storage device. The method can further include buffering data for an applications processor and reviving an applications processor when buffered data needs to be processed. The method can also include allowing the applications processor to access a data source not currently being used by the multimedia processor.

In a third embodiment of the present invention, a method for externally retrieving data from a data source coupled to a multimedia processor with a pass-thru architecture can include the steps of coupling at least one pass-thru port of a multimedia processor to at least one storage device port of a remote processor (where at least one pass-thru port is coupled to at least one storage device port of the multimedia processor), accessing a data source connected to at least one storage device port of the multimedia processor, retrieving data from the data source, and transferring the retrieved data to a remote file system of the remote processor (where the virtual file system of the multimedia processor is synchronized with a remote file system of a remote applications processor). The method can further include the step of enabling at least one pass-thru port where at least one pass-thru port is coupled to at least to at least one storage device port of the multimedia processor by a pass-thru controller managed by the multimedia processor. The method can also include automatically enabling a pass-thru port when the multimedia processor is dormant.

### BRIEF DESCRIPTION OF THE DRAWINGS

FIG. 1 is an illustration of a mobile device file sharing system as disclosed in the prior art.

FIG. 2 is an illustration of a mobile device file sharing system as disclosed in the prior art.

FIG. 3 is an illustration of a mobile device file sharing system as disclosed in the prior art.

FIG. 4 is an illustration of a mobile device file sharing system in accordance with an embodiment of the present invention.

FIG. 5 is an illustration of a mobile device file sharing system in accordance with an embodiment of the present invention.

FIG. 6 is a flow chart illustrating a method processing data with a multimedia processor with a pass-thru architecture in accordance with an embodiment of the present invention.

### DETAILED DESCRIPTION OF THE DRAWINGS

Embodiments in accordance with the invention disclosed herein provide a method and a system for sharing of a file system between a multimedia processor or accelerator and a baseband processor or application processor in a mobile device. Additionally embodiments herein provide for lower power consumption in a multiple processor system and increased bandwidth due to lower amounts of data transferred between a multimedia processor and an application processor. Additionally, the embodiments herein address digital TV processing requirements for a multimedia processor or digital signal processing (DSP) processor at the same time an application processor controls and runs digital TV operation, DVB-H stack control, and electronic service guides. The embodiments in accordance with the invention further address optimal performance for video playback, video recording, digital TV, still image capture, and DVR (Digital Video Recording) features on a mobile device.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

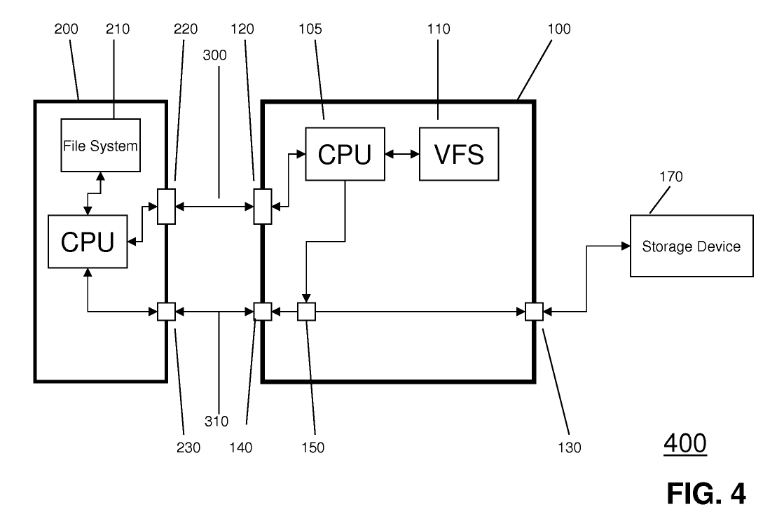

With reference now to the figures, FIG. 4 depicts a pictorial representation of a system in accordance with an embodiment of the present invention. The multimedia processor (MMP) or accelerator 100 is a processor or accelerator designed to efficiently process multimedia data and output such data for the user. Multimedia data may comprise of audio, video, or a combination thereof. More particularly, the MMP 100 may be designed to output data to a video screen, an audio speaker, or a file. In some embodiments, the MMP 100 can also record incoming multimedia data as well.

The MMP 100 further comprises a central processing unit (CPU) 105, a virtual file system (VFS) 110, and a plurality of ports. The plurality of ports includes at least one system bus port 120, a pass-thru storage device (PT/IO port) port 140, and a storage device (MM/IO port) port 130. In the various embodiments, the MM/IO port 130 can be coupled to a storage device or other data source. The VFS 110, the system bus port 120, and the MM/IO port 130 are all coupled to the CPU 105. The PT/IO port 140 is coupled to the MM/IO port 130 as well, via a pass-thru (PT) controller 150 managed by the CPU 105. The PT controller 150 provides the CPU 105 with the ability to signal the PT controller 150 to activate or deactivate the PT/IO port 140, thus preventing access of the data through the PT/IO port. In some embodiment, the PT/IO port 140 is normally active without any intervention from the CPU 105, thus allowing access of an associated data source to be active even if the CPU 105 is placed in a dormant state.

In the system 400 illustrated in FIG. 4, the system bus port 120 is used to couple the MMP 100 to applications processor (AP) 200 coupled to the system bus 300. Through the system bus 300, the MMP 100 has access to the AP 200 through an AP system bus port 220 and the AP file system 210 therein. Similarly, the AP 200 also has access to the MMP 100 and the VFS 110 therein. In the various embodiments, the system bus port 220 is used to synchronize file allocation table (FAT) data structures maintained on both the AP file system 210 and the VFS 110. In operation, the FAT file system data structures are kept identical between both processors like a cache, synchronizing all the write operations and the associated FAT table. Therefore, once a processor completes a write operation and the newly created file is closed, the FAT table in the AP 200 and/or the MMP 100 is updated depending on which processor executed the write operation. Note, the system 400 can be or form a part of a mobile wireless communication device.

The AP 200 is further adapted with at least one storage device (AP/IO port) port 230. In the various embodiments, the AP/IO port 230 and the PT/IO port 140 are coupled to the same I/O bus 310, thus allowing the AP 200 access to a storage device coupled to the MM/IO port 130 via the PT/IO port 140 coupled to the PT controller 150.

In operation, the MMP 100 works in two modes. In a first mode, the MMP 100 is required to access and process multimedia data from a data source or storage device 170 coupled to the MM/IO port 130. Prior to accessing the data, the CPU 105 signals the PT controller 150 to deactivate the PT/IO port 140. The CPU 105 can then copy the data to the VFS 110, which automatically updates the AP file system through the system bus 300, if necessary. In this mode, while the MMP 100 processes the multimedia data, the AP 200 is normally inactive. In the various embodiments, the AP 200 could be further adapted to enter a low power or dormant mode, thus reducing power consumption during use of the mobile device. In the various embodiments, the AP 200 is normally utilized to control some of the functions of the mobile device. For example, in a mobile phone, the AP 200 would be used to handle incoming and outgoing calls, connecting to the network, and other functions unrelated to the output or other processing of multimedia data. In this example, it is unnecessary to maintain the AP 200 operating at full power; rather the AP 200 can be configured to operate in a low power mode in which power is only used for the synchronization of the file system 210 with the VFS 110 of the MMP 100.

In a second mode of operation of the MMP 100, a pass-thru mode, the AP 200 can access data in the data source 170 coupled to the MM/IO port 130. In the various embodiments, the AP/IO port 230 can directly access the data source 170 coupled to the MM/IO port 130 through the PT/IO port 140. In such embodiments, the AP 200 can access the data source 170, as if the AP 200 were directly coupled to the data source 170. The AP 200 can then copy the data to the AP file system 210, which automatically updates the VFS 110 through the system bus 300, if necessary. In this mode, while the AP 200 processes the data retrieved, the MMP 100 is normally inactive.

In the various embodiments, the MMP 100 could be further adapted to enter a low power or dormant mode, thus reducing power consumption during use of the mobile device. In the various embodiments, the MMP 100 is normally utilized to control processing of multimedia data. For example, in a mobile phone, the MMP 100 would be used to handle playback and recording of audio/visual data being received over a mobile network or a digital TV tuner, not to control other functions of the mobile device. In such an example, it is unnecessary to maintain the MMP 100 operating at full power; rather the MMP 100 can be configured with a low power mode in which power is only used for the synchronization of the file system 210 with the VFS 110 of the MMP 100.

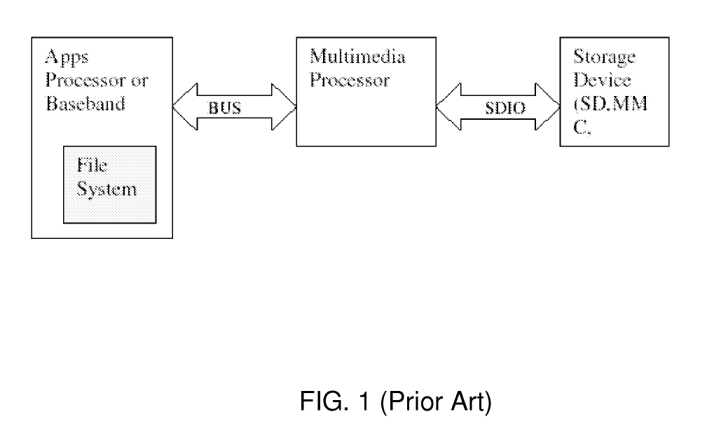

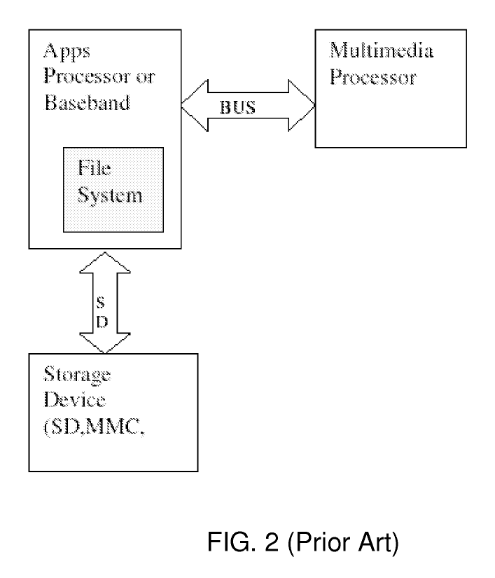

In either mode of operation, because the synchronization of the VFS 110 with the file system 210 is configured to require only minimal power usage by the AP 200 and the MMP 100, this is an improvement over the prior art as shown in FIGS. 1-3. The systems in the prior art require that at any time an MMP or a AP requires data only directly accessible to the other, both processors be fully active in order for the file transfer to occur and therefore require large quantities of power to do so. This combination of a pass-thru mode and VFS synchronization mechanism provides much lower power consumption to the multimedia mobile system with the best flexibility. Such systems can reduce power consumption for mobile digital TV technologies like DVB-H or on a multimedia player. Such a system can enable an increase in battery lifetime since the power requirements of an application processor will be reduced during standby mode.

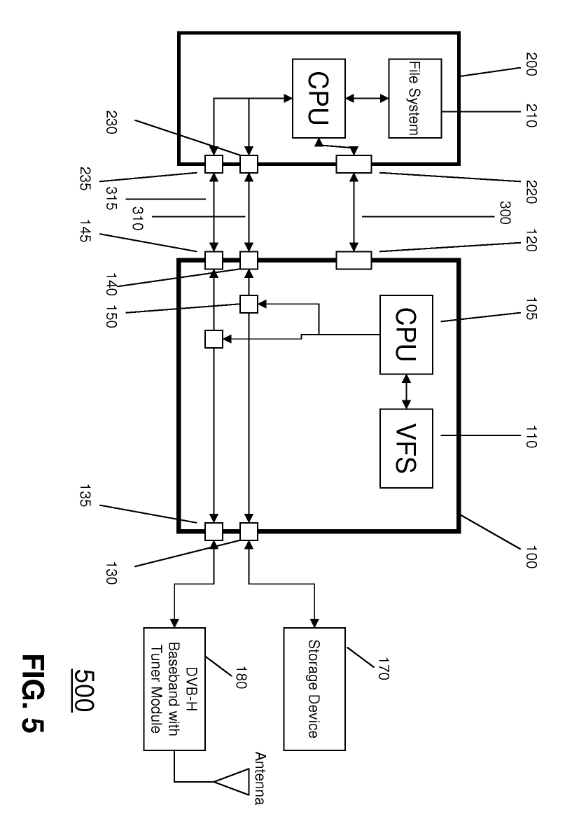

The use of such modes can also improve performance when dealing with more than one storage device or data source, as shown in the system 500 of FIG. 5. In such embodiments, although the basic operation of the MMP 200 and AP 100 is virtually identical, greater flexibility is allowed. In the system 500 illustrated in FIG. 5, the system is configured to allow access to multiple data sources (170 & 180). The MMP 200 is further adapted to comprise at least a second MM/IO port 135 and an associated second PT controller 155 and second PT/IO port 145. The AP 200 is also further adapted to comprise at least a second AP/IO port, coupled to the second PT/IO port, thus giving the AP 200 access a second storage device (180) coupled to the second MM/IO port 135. The ability to use such modes and multiple data sources is utilized for new mobiles device features such as DVB-H or other multimedia content delivery services for mobile devices, such as MEDIAFLO™.

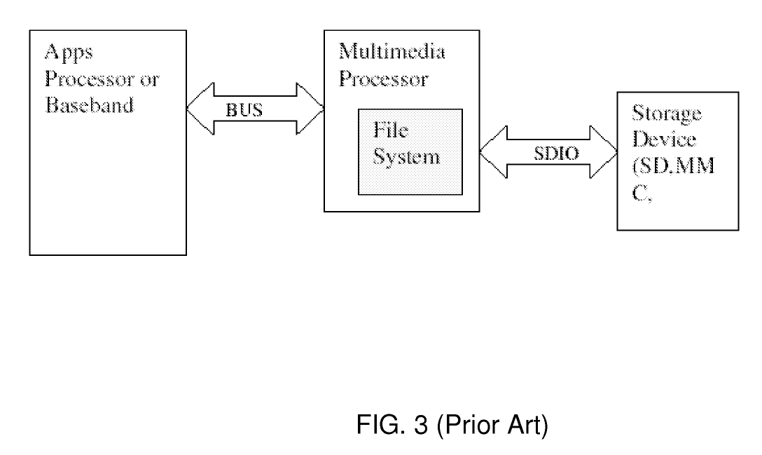

For example, in a DVB-H digital TV mode of operation for a mobile device, a DVB-H modulator or a DVB-H demodulator/tuner chip combo 180 could be coupled to the second MM/IO port 135. For this mode, the DVB-H baseband may be monitoring several MPEG2 transport stream program IDs (PID) at any given time. For example one PID may be related with the electronic service guide, a different one with a particular TV channel. On the typical handset using the prior art, such as the system in FIG. 3, for example could not be used since the user interface related with an electronic service guide and other interactive services is handled by an applications processor.

In the various embodiments, the invention allows the DVB-H MPEG2 transport stream Program ID (PID) with the channel data in H.264 or MPEG4 and audio data to be processed by the MMP 100 without any intervention from the AP 200. As discussed before, the AP 200 will be prevented from accessing the MM/IO port during the time the MMP 100 is accessing this particular program ID. However, the AP 200 can have access to any PID trough the pass-thru mode when not in DVB-H broadcasting TV mode. Therefore, the DVB-H MPEG2 transport stream PID with the electronic service guide data can be read by AP 200 during the pass-thru mode.

However during broadcast mode, the AP 200 processor can operate in a low power mode when the MMP 100 is processing video from the DVB-H stream (180) or other data source. In some embodiments when operating in a DVB-H or mobile broadcast mode, the MMP 100 can also monitor for IP packets needed by the AP 200. As the IP packets arrive, the MMP 100 will buffer them and wakeup the AP 200 only when needed. In other words, the AP 200 can instruct the MMP 100 as to which IP packets the AP 200 needs to be alerted to and if MMP 100 needs to buffer these IP packets. This buffer option allows the AP 200 to remain in dormant state longer, yet not miss any communications. For example, instead of having to wakeup every 2 seconds, by buffering on the MMP 100, the AP 200 may only need to wake up every 3-4 seconds increasing battery life on mobile TV operation.

In the various embodiments, since the AP 200 is in a low power mode, this allows the mobile device operate with the lowest power requirements possible during digital TV playback and/or recording. Additionally, since both the digital TV and storage facilities are available to the MMP 100 without interference by the AP 200, this enables use of digital video recording (DVR) features on the mobile device, in which a broadcast channel is recorded automatically on a mass storage device while synchronizing of the VFS 110 operates at the lowest possible power. However, the AP 200 will still have access to other programs ID when program data is not being received in a particular slot.

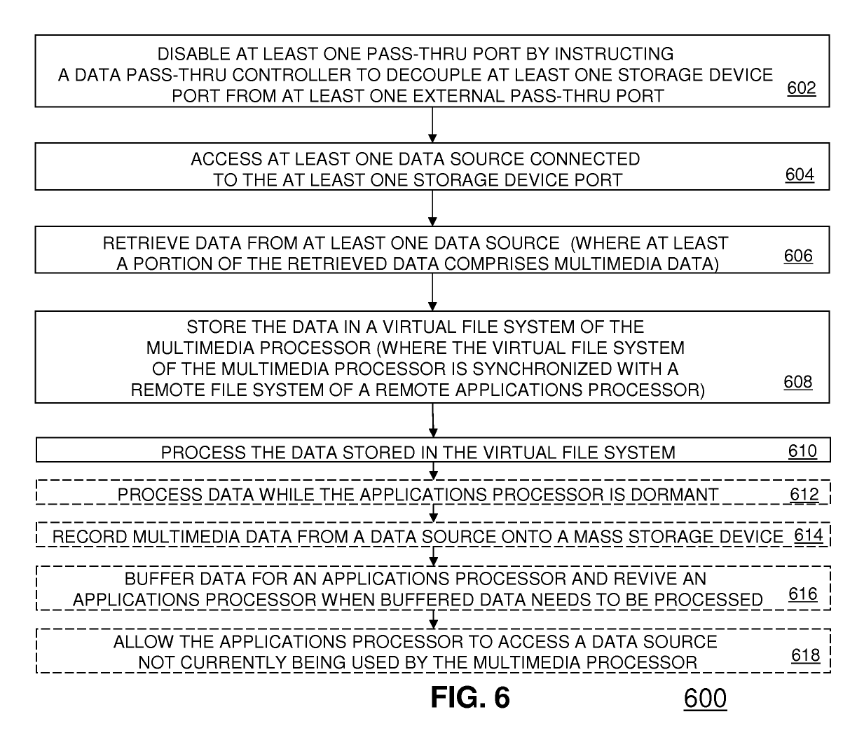

Referring to FIG. 6, a method 600 for processing data with a multimedia processor with a pass-thru architecture can include the step 602 of disabling at least one pass-thru port by instructing a data pass-thru controller to decouple at least one storage device port from at least one external pass-thru port, accessing at least one data source connected to at least one storage device port at step 604, retrieving data from at least one data source (where at least a portion of the retrieved data comprises multimedia data) at step 606, storing the data in a virtual file system of the multimedia processor (where the virtual file system of the multimedia processor is synchronized with a remote file system of a remote applications processor) at step 608, and processing the data stored in the virtual file system at step 610. The method 600 can further include the step 612 of processing data while the applications processor is dormant. The method 600 can also include the step 614 of recording multimedia data from a data source onto a mass storage device. The method 600 can further buffer data for an applications processor and revive an applications processor when buffered data needs to be processed at step 616. The method 600 can also include allowing the applications processor to access a data source not currently being used by the multimedia processor at step 618.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A multimedia processor system for a mobile device, the system comprising:
a central processing unit (CPU);
a system bus port accessible by the CPU;
a virtual file system (VFS) accessible by the CPU, wherein the VFS is synchronized with a remote file system of a remote application processor coupled to the system bus port;
at least one storage device port accessible by the CPU; and,
at least one storage device pass-thru port coupled to the at least one storage device port by a pass-thru controller managed by the CPU, wherein the CPU instructs the pass-thru controller to disable access of the at least one pass-thru port to the at least one storage device port.

2. The processor system of claim 1, wherein the CPU is only active only during multimedia events and dormant during other events on the mobile device.

3. The processor system of claim 2, wherein the pass-thru controller automatically enables access to the at least one pass-thru port when the CPU is dormant.

4. The processor system of claim 1, wherein the at least one storage device port accesses a mass storage device.

5. The processor system of claim 1, wherein the at least one storage device port accesses a multimedia stream.

6. The processor system of claim 5, wherein at least one other storage device port accesses a mass storage device, wherein the CPU can record the multimedia stream to the mass storage device through the synchronized VFS while the remote application processor is dormant.

7. A method for processing data with a multimedia processor with a pass-thru architecture, comprising the steps of:
disabling at least one pass-thru port by instructing a data pass-thru controller to decouple at least one storage device port from at least one external pass-thru port;
accessing at least one data source connected to the at least one storage device port;
retrieving data from the at least one data source, wherein at least a portion of the retrieved data comprises multimedia data;
storing the data in a virtual file system of the multimedia processor, wherein the virtual file system of the multimedia processor is synchronized with a remote file system of a remote applications processor; and,
processing the data stored in the virtual file system.

8. The method of claim 7, wherein at least one other data source comprises a mass storage device.

9. The method of claim 8, wherein the processing step further comprises:
recording the multimedia data onto the mass storage device through the synchronized virtual file system.

10. The method of claim 7, wherein the retrieved data comprises a multimedia stream.

11. The method of claim 7, further comprising the steps of:
receiving an instruction to monitor the retrieved data for data needed by a dormant application processor;
buffering at least a portion of the data needed by a dormant application processor; and,
reviving the dormant application processor to process the buffered data.

12. The method of claim 7, wherein at least one other pass-thru port is enabled, wherein at least one other pass-thru port is coupled to at least one other storage device port coupled to at least one other data source, whereby a remote applications processor can access at least one other data source through at least one other pass-thru port.

13. A method for externally retrieving data from a data source coupled to a multimedia processor with a pass-thru architecture, comprising the steps of:
coupling at least one pass-thru port of a multimedia processor to at least one storage device port of a remote processor; wherein at least one pass-thru port is coupled to at least one storage device port of the multimedia processor;
accessing a data source connected to at least one storage device port of the multimedia processor;
retrieving data from the data source;
transferring the retrieved data to a remote file system of the remote processor;
wherein the virtual file system of the multimedia processor is synchronized with a remote file system of a remote applications processor.

14. The method of claim 13, the step of coupling further comprising the step of:
enabling at least one pass-thru port, wherein at least one pass-thru port is coupled to at least to at least one storage device port of the multimedia processor by a pass-thru controller managed by the multimedia processor.

15. The method of claim 16, wherein at least one pass-thru port is automatically enabled when the multimedia processor is dormant.

16. The method of claim 13, wherein the data source comprises a mass storage device.
